(19) United States
(12) Patent Application Publication
(10) Pub. No.: US 2010/0313915 A1
(43) Pub. Date: Dec. 16, 2010

(54) SUBSTRATE CLEANING METHOD AND SUBSTRATE CLEANING APPARATUS

(76) Inventors: Naozumi Fujiwara, Kyoto (JP); Masahiko Kato, Kyoto (JP); Katsuhiko Miya, Kyoto (JP)

Correspondence Address: OSTROLENK FABER GERB & SOFFEN, 1180 AVENUE OF THE AMERICAS, NEW YORK, NY, 100368403, US

(21) Appl. No.: 12/918,004

(22) PCT Filed: Aug. 21, 2009
(86) PCT No.: PCT/JP2009/004010

§ 371 Date: Aug. 17, 2010

(30) Foreign Application Priority Data
Sep. 25, 2008 (JP) 2008-245564

(51) Int. Cl. B08B 3/04; B08B 3/10

(52) U.S. Cl. 134/33; 134/36; 134/102.1

(57) ABSTRACT

The substrate cleaning method of and the substrate cleaning apparatus for removing contaminants such as particles adhering to a surface of a substrate attain a high throughput and effectively remove the particles and the like. To clean the back surface Wb of the substrate W, DIW cooled down to a temperature near its freezing point and cooling gas which is at a lower temperature than the freezing point of the DIW are discharged toward the center of the lower surface of the substrate which rotates. When thus cooled DIW flows along the back surface Wb of the substrate W, the particles and the like adhering to the substrate are removed.

### TECHNICAL FIELD

The present invention relates to a substrate cleaning method and a substrate cleaning apparatus for removal of contaminants such as particles adhering to surfaces of substrates. The substrates may be semiconductor wafers, glass substrates for photomasks, glass substrates for liquid crystal displays, glass substrates for plasma displays, optical disk substrates, etc.

### BACKGROUND ART

The freeze cleaning technique has been known as one of processing methods of removing contaminants such as particles adhering to surfaces of substrates. In this technique, a liquid film formed on a surface of a substrate is frozen, the frozen film is removed, and particles and the like are removed together with the frozen film from the surface of the substrate. For instance, according to the technique described in the patent literature 1, after supplying DIW (deionized water) serving as cleaning liquid onto a surface of a substrate and forming a liquid film, a nozzle for discharging cooling gas scans near the surface of the substrate so that the liquid film is frozen. Following this, DIW is supplied once again and the frozen film is removed, whereby particles are removed from the surface of the substrate.

### Citation Document

### Patent Document

Patent Document 1: JP-A-2008-071875 (FIG. 5)

### SUMMARY OF THE INVENTION

### Problems to be Solved by the Invention

As the conventional technique described above requires to perform in order the three steps of (1) forming the liquid film, (2) freezing the liquid film and (3) removing the frozen film, the process takes time, which leaves a room for further improvement of the throughput. Particularly when one tries to improve the capability of removing particles etc., it is necessary in the conventional technique above to thicken the liquid film which needs be formed or extend the time of supplying the cooling gas. However, this would further increase the processing time, thus it is difficult to improve both the capability of removing particles and the like and the throughput of the processing.

The invention has been made in light of the problem above, and accordingly, aims at providing a technique for realization of a high throughput and effective removal of particles and the like in a substrate cleaning method of and a substrate cleaning apparatus for removing contaminants such as particles adhering to surfaces of substrates.

### Means for Solving the Problems

To achieve the object above, the substrate cleaning method according to the invention comprises: a cleaning liquid supplying step of discharging and supplying cleaning liquid toward a substrate; and a cleaning liquid removing step of removing the cleaning liquid remaining on a surface of the substrate after the cleaning liquid supplying step, wherein at the cleaning liquid supplying step, while discharging the cleaning liquid, cooling gas which is at a lower temperature than a freezing point of the cleaning liquid is supplied toward the cleaning liquid thus discharged.

To achieve the object above, the substrate cleaning apparatus according to the invention comprises: a substrate holder which holds a substrate; a cleaning liquid supplier which discharges and supplies cleaning liquid toward the substrate which is held by the substrate holder; and a cooling gas supplier which supplies cooling gas to the cleaning liquid which is discharged by the cleaning liquid supplier, wherein the cooling gas supplier supplies the cooling gas which is at a lower temperature than a freezing point of the cleaning liquid to the cleaning liquid which is discharged toward the substrate by the cleaning liquid supplier.

As described in detail later, the inventors of the invention conducted an experiment that while supplying cleaning liquid to a substrate, cooling gas at a lower temperature than the freezing point of the cleaning liquid was brought into contact with the cleaning liquid to cool the cleaning liquid. As a result, it was found that even then entire surface of a liquid film on a surface of a substrate was not frozen, the same or better particle removal effect than that according to the conventional freeze cleaning technique would be achieved. Further, as the cooling gas is supplied while supplying the cleaning liquid, it is possible to process at a higher throughput than where the conventional technique which requires to form and freeze the liquid film in this order is utilized. That is, with the substrate cleaning method and the substrate cleaning apparatus according to the invention, it is possible to obtain a high throughput and effectively remove particles and the like.

### EFFECTS OF THE INVENTION

According to the invention, while supplying cleaning liquid to substrates, cooling gas which is at a lower temperature than the freezing point of the cleaning liquid is supplied in order to cool the cleaning liquid. Therefore, it is possible to remove particles and the like adhering to surfaces of substrates at a higher throughput and for a greater cleaning effect as compared to a technique which requires to freeze a liquid film after forming a liquid film of cleaning liquid.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF DRAWINGS

FIG. 1 is a drawing which shows the substrate processing apparatus according to the first embodiment of the invention;

FIG. 2 is a block diagram of the configuration for controlling the substrate processing apparatus of FIG. 1;

FIG. 3A is a drawing which shows the structure of the upper surface of a spin base 23;

FIG. 3B is a cross sectional view of the spin base;

FIG. 4 is a flow chart which shows the cleaning operation of the substrate processing apparatus of FIG. 1;

FIG. 5A is a schematic diagram of the cleaning operation;

FIG. 5B is a schematic diagram of the cleaning operation;

FIG. 5C is a schematic diagram of the cleaning operation;

FIG. 5D is a schematic diagram of the cleaning operation;

FIG. 6A is a schematic diagram of the cleaning operation;

FIG. 6B is a schematic diagram of the cleaning operation;

FIG. 7 is a drawing which describes the experiment the inventors of the invention performed;

FIG. 8 is a drawing which shows the relationship between the liquid temperature of DIW and the particle removal efficiency;

FIG. 9 is a drawing which shows the relationship between the temperature of the cooling gas and the particle removal efficiency;

FIG. 10 is a drawing which shows the relationship between the number of rotations of the substrate and the particle removal efficiency;

FIG. 11A is a drawing which shows the model of the particle removal mechanism in this cleaning technique;

FIG. 11B is a drawing which shows the model of the particle removal mechanism in this cleaning technique;

FIG. 12 is a drawing which shows the substrate processing apparatus according to the second embodiment of the invention;

FIG. 13 is a flow chart which shows the cleaning operation of the substrate processing apparatus of FIG. 12.

### EMBODIMENTS FOR CARRYING OUT THE INVENTION

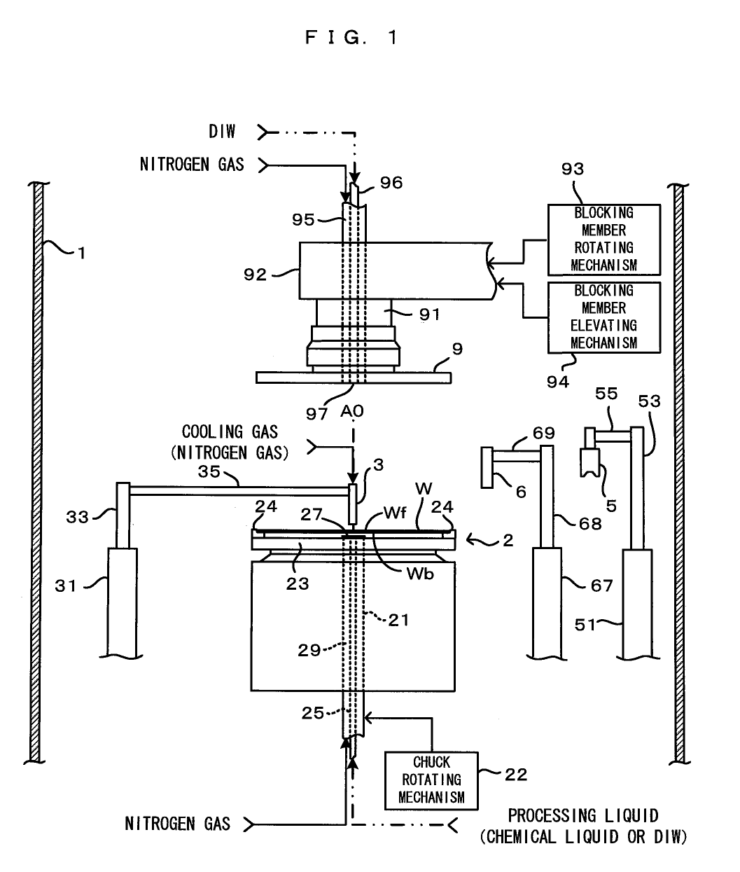

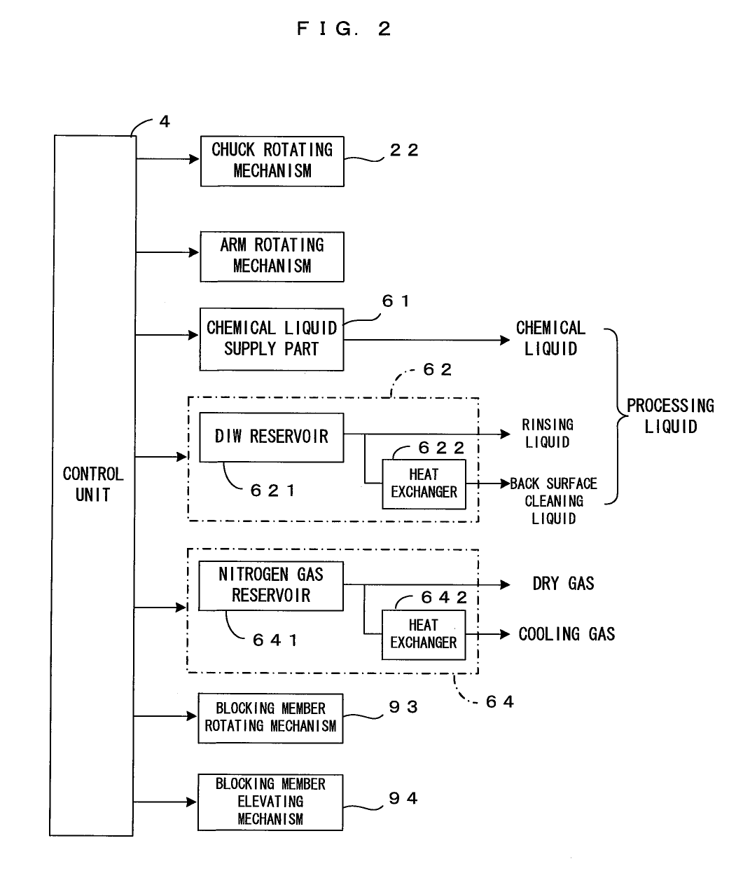

FIG. 1 is a drawing which shows the substrate processing apparatus according to the first embodiment of the invention. FIG. 2 is a block diagram of the configuration for controlling the substrate processing apparatus of FIG. 1. This substrate processing apparatus is a single-wafer type substrate cleaning apparatus which is capable of executing the substrate cleaning process of removing contaminants such as particles adhering to a front surface Wf and a back surface Wb of a substrate W such as a semiconductor wafer. More specifically, it is a substrate processing apparatus which removes particles and the like from the front surface Wf of the substrate bearing micro-patterns using the known freeze cleaning technique and from the back surface Wb of the substrate opposite to the front surface Wf using the cleaning technique according to the invention.

This substrate processing apparatus includes a processing chamber 1 which has a processing space inside in which the cleaning process is performed on the substrate W. Disposed within the processing chamber 1 are a spin chuck 2 which rotates the substrate W while holding the substrate W approximately horizontally with the front surface Wf directed toward above, a cooling gas discharge nozzle 3 which discharges cooling gas for freezing a liquid film toward the front surface Wf of the substrate W which is held by the spin chuck 2, a two-fluid nozzle 5 which supplies drops of processing liquid to the front surface Wf of the substrate, a chemical liquid discharge nozzle 6 which discharges chemical liquid toward the front surface Wf of the substrate W held by the spin chuck 2, and a blocking member 9 which is disposed facing the front surface Wf of the substrate W held by the spin chuck 2. The processing liquid may be the chemical liquid or cleaning liquid such as pure water and DIW (deionized water).

In the spin chuck 2, a rotation spindle 21 is coupled to the rotation shaft of a chuck rotating mechanism 22 which contains a motor. When driven by the chuck rotating mechanism 22, the rotation spindle 21 rotates about the center of rotation A0. A disk-shaped spin base 23 is coupled by a fastening component such as a screw to the top end of the rotation spindle 21 to form one integrated part. Hence, the spin base 23 rotates about the center of rotation A0 as the chuck rotating mechanism 22 operates in response to an operation command received from a control unit 4 (FIG. 2) which controls the entire apparatus.

Plural chuck pins 24 for holding the substrate W at the rim thereof are disposed upright in the vicinity of the rim of the spin base 23. There may be three or more chuck pins 24 to securely hold the disk-shaped substrate W. The chuck pins 24 are arranged at equal angular intervals along the rim of the spin base 23. Each chuck pin 24 comprises a bottom surface supporting part which supports the substrate W at the rim thereof from below and an edge surface holding part which presses the substrate W at the outer peripheral edge surface thereof and holds the substrate W supported by the bottom surface supporting part. Each chuck pin 24 has such a structure which makes it possible to switch between a pressing state in which the edge surface holding part presses the substrate W at the outer peripheral edge surface thereof and a release state in which the edge surface holding part stays away from the outer peripheral edge surface of the substrate W.

The chuck pins 24 are in the release state while the substrate W is being transferred to the spin base 23 but in the pressing state for cleaning of the substrate W. When in the pressing state, the chuck pins 24 hold the substrate W at the rim of the substrate, maintaining the substrate W approximately horizontally over a predetermined distance from the spin base 23. The substrate W is thus held with its front surface (pattern-seating surface) Wf directed toward above and its back surface Wb toward below.

A first rotation motor 31 is disposed outside the spin chuck 2. A first rotation shaft 33 is connected with the first rotation motor 31. A first arm 35 is coupled to the first rotation shaft 33 so as to extend in the horizontal direction, and the cooling gas discharge nozzle 3 is attached to the tip of the first arm 35. As the first rotation motor 31 operates in response to an operation command from the control unit 4, the first arm 35 pivots about the rotation shaft 33.

The cooling gas discharge nozzle 3 is connected with a gas supply part 64 (FIG. 2), and cooling gas is supplied to the cooling gas discharge nozzle 3 from the gas supply part 64 in accordance with an operation command from the control unit 4. More specifically describing, a heat exchanger 642 cools nitrogen gas supplied from a nitrogen gas storage reservoir 641 disposed in the gas supply part 64 to a lower temperature than the freezing point of DIW, and thus cooled nitrogen gas is supplied to the cooling gas discharge nozzle 3 as the cooling gas. As the cooling gas discharge nozzle 3 becomes opposed to the front surface Wf of the substrate, the cooling gas discharge nozzle 3 discharges cooling gas toward the front surface Wf of the substrate. The cooling gas is supplied to the entire front surface Wf of the substrate, as the cooling gas discharge nozzle 3 moves toward an outer peripheral portion of the substrate from the center of rotation of the substrate while the cooling gas discharge nozzle 3 discharges the cooling gas and while the control unit 4 keeps the substrate W rotated. When a liquid film of DIW is already present on the front surface Wf of the substrate as described later, it is possible to freeze the liquid film as a whole and form a frozen film of DIW on the entire front surface Wf of the substrate.

Further, a second rotation motor 51 is disposed outside the spin chuck 2. A second rotation shaft 53 is connected with the first rotation motor 51, and a second arm 55 is coupled to the second rotation shaft 53. The two-fluid nozzle 5 is attached to the tip of the second arm 55. As the second rotation motor 51 operates in response to an operation command from the control unit 4, the two-fluid nozzle 5 swings about the second rotation shaft 53. This two-fluid nozzle is a two-fluid nozzle of the so-called external mix type which requires crashing the nitrogen gas with DIW serving as the processing liquid in the air (i.e., outside the nozzle) to create drops of DIW.

In addition, a third rotation motor 67 is disposed outside the spin chuck 2. A third rotation shaft 68 is connected with the third rotation motor 67. A third arm 69 is coupled to the third rotation shaft 68 so as to extend in the horizontal direction, and the chemical liquid discharge nozzle 6 is attached to the tip of the third arm 69. As the third rotation motor 67 operates in response to an operation command from the control unit 4, the chemical liquid discharge nozzle 6 reciprocates between a discharging position above the center of rotation A0 of the substrate W and a standby position which is away to the side from the discharging position. The chemical liquid discharge nozzle 6 is connected with a chemical liquid supply part 61. In accordance with an operation command from the control unit 4, the chemical liquid such as an SC1 solution (which is an aqueous mixture of aqueous ammonia and a hydrogen peroxide solution) is supplied from the chemical liquid supply par 61 to the chemical liquid discharge nozzle 6.

As the cooling gas discharge nozzle 3, the two-fluid nozzle 5, the chemical liquid discharge nozzle 6 and the arms, the rotating mechanisms and the like associated with them, those having the same structures as what are described in the patent literature 1 mentioned above (JP-A-2008-071875) may be used for instance. These structures will not therefore be described in any more details here.

The blocking member 9 which is shaped like a disk which has an opening at its center is disposed above the spin chuck 2. The lower surface (the bottom surface) of the blocking member 9 is a substrate-facing surface which is opposed and approximately parallel to the front surface Wf of the substrate W, and the plane size of the lower surface is equal to or larger than the diameter of the substrate W. The blocking member 9 is attached approximately horizontally to the bottom end of a support shaft 91 which is shaped approximately like a circular cylinder. An arm 92 extending in the horizontal direction holds the support shaft 91 in such a manner that the support shaft 91 can rotate about a vertical axis which penetrates with the center of the substrate W. Further, a blocking member rotating mechanism 93 and a blocking member elevating mechanism 94 are connected with the arm 92.

In response to an operation command from the control unit 4, the blocking member rotating mechanism 93 rotates the support shaft 91 about the vertical axis which penetrates the center of the substrate W. The blocking member rotating mechanism 93 is so structured to rotate the blocking member 9 at about the same rotation speed in the same direction as the substrate W in accordance with rotation of the substrate W which is held by the spin chuck 2.

Meanwhile, the blocking-member elevating mechanism 94 is capable of moving the blocking member 9 toward and away from the spin base 23 in accordance with an operation command from the control unit 4. Specifically, the blocking-member elevating mechanism 94 moves the blocking member 9 upward to a separated position (that is, the position shown in FIG. 1) above the spin chuck 2 for loading and unloading of the substrate W into and from the substrate processing apparatus. In contrast, for execution of predetermined processing of the substrate W, the blocking-member elevating mechanism 94 moves the blocking member 9 downward to an opposed position which is set to be very close to the front surface Wf of the substrate W held by the spin chuck 2.

The support shaft 91 is hollow and accepts in its hollow a gas supply pipe 95 which extends to the opening of the blocking member 9. The gas supply pipe 95 is connected with the gas supply part 64, and nitrogen gas coming from the nitrogen gas reservoir 641 without going through the heat exchanger 642 is supplied as dry gas. In this embodiment, during post-cleaning drying of the substrate W, the nitrogen gas is supplied via the gas supply pipe 95 into the space which is formed between the blocking member 9 and the front surface Wf of the substrate W. Further, a liquid supply pipe 96 extending to the opening of the blocking member 9 is inserted inside the gas supply pipe 95, and a nozzle 97 is coupled to the bottom end of the liquid supply pipe 96. The liquid supply pipe 96 is connected with the DIW supply part 62, thereby making it possible to supply DIW from the DIW supply part 62 and discharge the DIW at the nozzle 97 as rinsing liquid toward the front surface Wf of the substrate.

The DIW supply part 62 comprises a DIW reservoir 621 and a heat exchanger 622. The heat exchanger 622 cools DIW supplied from the DIW reservoir 621 down to a temperature which is near the freezing point of the DIW. In short, the DIW supply part 62 is capable of supplying DIW which comes from the DIW reservoir 621 and therefore is at a room temperature and is capable of supplying DIW cooled by the heat exchanger 622 down to the temperature which is close to the freezing point of the DIW.

The rotation spindle 21 of the spin chuck 2 is a hollow spindle. A processing liquid supply pipe 25 for supplying the processing liquid to the back surface Wb of the substrate W is laid inside and through the rotation spindle 21. The gap between the inner wall surface of the rotation spindle 21 and the outer wall surface of the processing liquid supply pipe 25 defines a cylindrical gas supply path 29. The processing liquid supply pipe 25 and the gas supply path 29 extend to a position near the lower surface (the back surface Wb) of the substrate W which is held by the spin chuck 2, and seat at their tip ends a lower surface nozzle 27 which is for discharging the processing liquid and gas toward a central portion of the lower surface of the substrate W.

The processing liquid supply pipe 25 is connected with the chemical liquid supply part 61 and the DIW supply part 62. The chemical liquid such as an SC1 solution supplied from the chemical liquid supply part 61 or DIW supplied from the DIW supply part 62 is selectively supplied to the processing liquid supply pipe 25. On the other hand, the supply path 29 is connected with the nitrogen gas supply part 64, and therefore, it is possible to supply the nitrogen gas from the nitrogen gas supply part 64 into the space which is formed between the spin base 23 and the back surface Wb of the substrate.

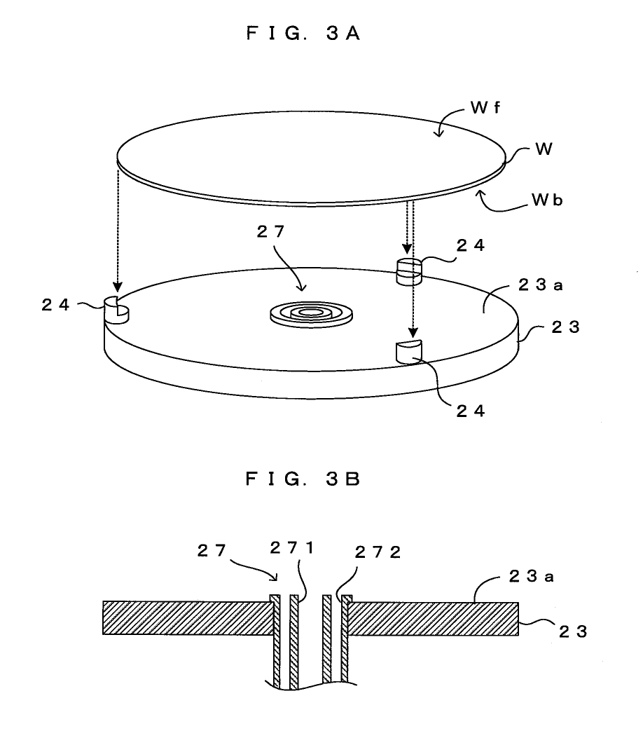

FIGS. 3A and 3B are drawings which show the structure of the spin base. Specifically, FIG. 3A is a drawing which shows the structure of the upper surface of a spin base 23, and FIG. 3B is a cross sectional view of the spin base. As shown in FIG. 3A, the multiple chuck pins 24 are disposed upright at the outer peripheral edge of the upper surface 23a of the spin base 23 and capable of approximately horizontally holding the substrate W which needs be processed.

The lower surface nozzle 27 is disposed at the center of the upper surface 23a of the spin base. As shown in FIGS. 3A and 3B, the lower surface nozzle 27 comprises a first discharge outlet 271 which is open toward the center of rotation of the substrate and a second discharge outlet 272 which is open coaxially to the first discharge outlet 271 as if to surround the first discharge outlet 271. The first discharge outlet 271 extends to the processing liquid supply pipe 25 so that the chemical liquid such as an SC1 solution coming from the chemical liquid supply part 61 or DIW coming from the DIW supply part 62 is discharged at the first discharge outlet toward the lower surface of the substrate (that is, the back surface Wb of the substrate which does not bear any pattern in this embodiment). Meanwhile, the second discharge outlet 272 extends to the gas supply path 29 so that the nitrogen gas from the nitrogen gas supply part 64 is discharged at the second discharge outlet. Hence, thus discharged nitrogen gas is fed toward the position on the lower surface of the substrate where DIW is received or a proximity position around this position.

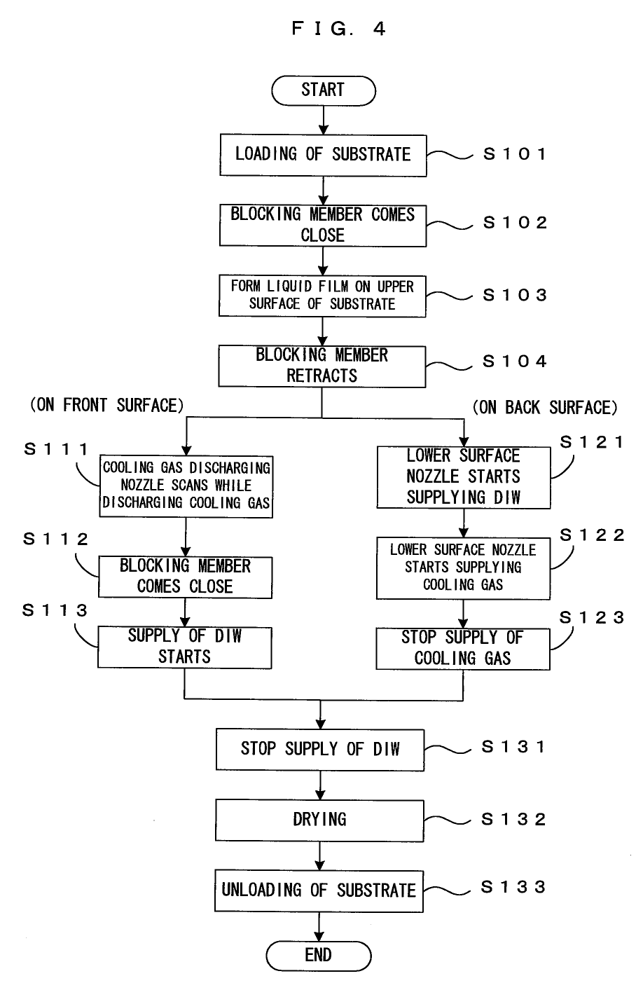

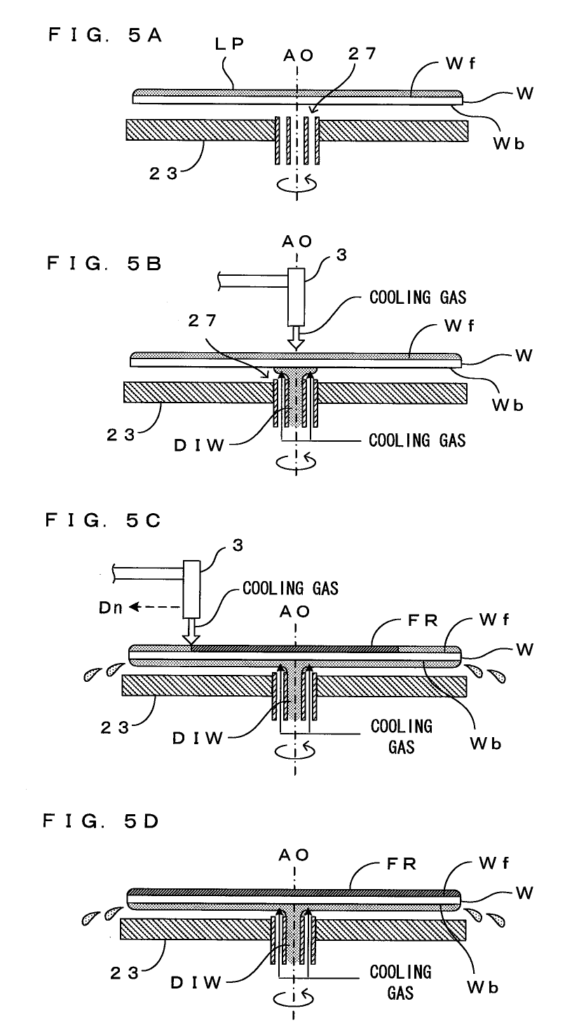

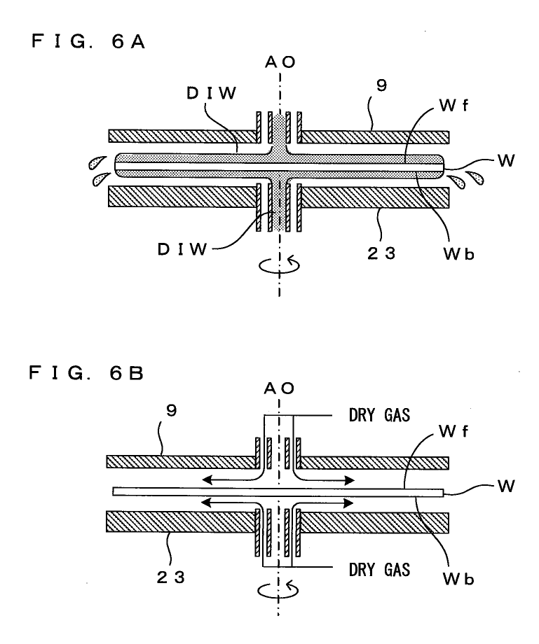

The cleaning operation in the substrate processing apparatus having the structure above will now be described with reference to FIGS. 4 through 6B. FIG. 4 is a flow chart which shows the cleaning operation of the substrate processing apparatus of FIG. 1. FIGS. 5A, 5B, 5C, 5D, 6A through 6B are schematic diagrams of the cleaning operation. In this apparatus, when an unprocessed substrate W is loaded into inside the apparatus, the control unit 4 controls the respective sections of the apparatus and the cleaning process is performed upon the substrate W. In the event that the front surface Wf of the substrate seats micro-patterns, the substrate W is loaded into inside the processing chamber 1 with its front surface Wf directed toward above, and is then held by the spin chuck 2 (Step S101). The blocking member 9 is located at the separated position, which prevents interference with the substrate W.

As the spin chuck 2 holds the unprocessed substrate W, the blocking member 9 descends to the opposed position and becomes positioned close to the front surface Wf of the substrate (Step S102). The front surface Wf of the substrate gets therefore covered in such a manner that it is located in the vicinity of the substrate-facing surface of the blocking member 9, and is blocked from the surrounding atmosphere surrounding the substrate. The control unit 4 then activates the chuck rotating mechanism 22, thereby rotating the spin chuck 2 and making the nozzle 97 supply room-temperature DIW to the front surface Wf of the surface. Centrifugal force which develops as the substrate W rotates acts upon the DIW supplied to the front surface Wf of the substrate, and the DIW uniformly spreads outwardly in the diameter direction of the substrate W and is partially shaken off from the substrate. This controls the thickness of the liquid film uniform all over the entire front surface Wf of the substrate, whereby the liquid film (an aqueous film) having a predetermined thickness is formed on the entire front surface Wf of the substrate (Step S103). During formation of the liquid film, it is not essential to shake off a part of the DIW supplied to the front surface Wf of the substrate in the fashion described above. For example, the liquid film may be formed on the front surface Wf of the substrate in the condition that the substrate W has stopped rotating or rotates at a relatively slow speed, without shaking off the DIW from the substrate W.

In this state, the front surface Wf of the substrate W seats a puddle-like liquid film LP which has a predetermined thickness as shown in FIG. 5A. After the liquid film has been formed in this manner, the control unit 4 retracts the blocking member 9 back to the separated position (Step S104). Following this, the processes below are performed respectively on the front surface Wf and the back surface Wb of the substrate W in parallel. The puddle-like liquid film LP may be formed by the SC1 liquid supplied at the chemical liquid discharge nozzle 6.

On the front surface side of the substrate, the cooling gas discharge nozzle 3 moves from the standby position toward above the center of rotation of the substrate. As shown in FIG. 5B, cooling gas is discharged at the cooling gas discharge nozzle 3 toward the front surface Wf of the rotating substrate W, and the cooling gas discharge nozzle 3 gradually moves to a position at the edge of the substrate W (Step S111). As a result, the liquid film LP formed in a section on the front surface Wf of the substrate gets cooled and partially frozen, and as shown in FIG. 5C, a section thus frozen (namely, a frozen region FR) is formed in a central part of the front surface Wf of the substrate. As the nozzle 3 scans to a direction Dn, the frozen region FR spreads from the central part of the front surface Wf of the substrate toward the rim of the substrate, and as shown in FIG. 5D, the entire surface of the liquid film is eventually frozen on the front surface Wf of the substrate. As the entire liquid film freezes, the cooling gas discharge nozzle 3 moves back while the blocking member 9 comes close to the front surface Wf of the substrate (Step S122), and from the nozzle 97 disposed to the blocking member 9, room-temperature DIW is supplied toward the frozen liquid film which is on the front surface Wf of the substrate.

On the other hand, on the back surface side of the substrate, DIW from the first discharge outlet 271 of the lower surface nozzle 27 disposed in the spin base 23 is supplied as back surface cleaning liquid toward the back surface Wb of the substrate (Step S121), and at the same time as this or in a slight delay from this, nitrogen gas is discharged from the second discharge outlet 272 of the lower surface nozzle 27 (Step S122). As a result, as shown in FIGS. 5B through 5D, the liquid film of the DIW is formed spreading from the center of the back surface Wb of the substrate toward outside, and the DIW is eventually shaken off at the edge of the substrate.

The DIW and the nitrogen gas supplied from the lower surface nozzle 27 to the back surface Wb of the substrate have been cooled respectively by the heat exchangers 622 and 642. As described in detail later, according to the experiment by the inventors of the invention, as DIW cooled down to a temperature near the freezing point of the DIW and gas (cooling gas) cooled down to a lower temperature than the freezing point of the DIW are discharged toward a substrate, it is possible to attain a high particle removal efficiency. After continued supply of the cooling gas for a predetermined period of time, preferably, until the liquid film completely freezes on the front surface side of the substrate, the supply of the cooling gas is stopped (Step S123).

At the time that the process has come to this stage, as shown in FIG. 6A, the DIW is being supplied to the both surfaces of the substrate W while the substrate W keeps rotating as it is held between the blocking member 9 and the spin base 23. At this stage, instead of supplying the room-temperature DIW to the front surface Wf of the substrate, drops of the DIW may be supplied at the two-fluid nozzle 5. The supply of the DIW to the both surfaces of the substrate is then stopped (Step S131), and drying of the substrate is performed (Step S132). That is, as shown in FIG. 6B, the substrate W rotates at a high speed while discharging nitrogen gas from the nozzle 97 disposed to the blocking member 9 and the lower surface nozzle 3 disposed to the spin base 23, thereby shaking off the DIW remaining on the substrate W and drying the substrate W. The nitrogen gas supplied at this stage, serving as dry gas, is gas at a room temperature which does not go through the heat exchanger 642. After completion of the drying, the processed substrate W is unloaded and the process of one substrate completes (Step S133).

The cleaning effect of the process above will now be described. First, the processing of the front surface Wf of the substrate is the known freeze cleaning technique. As the liquid film is frozen in the manner described above, the volume of the liquid film edging into between particles and the front surface Wf of the substrate bulges (The volume increases approximately by 1.1 times as water at 0 degrees Celsius changes to ice at 0 degrees Celsius.), and the particles move away from the front surface Wf of the substrate by very short distances. This reduces adhesion force between the front surface Wf of the substrate and the particles and further encourages separation of the particles from the front surface Wf of the substrate. Even where the front surface Wf of the substrate seats micro-patterns, the pressure applied upon the patterns by the expanding volume of the liquid film is equal in all directions, that is, the force upon the patterns is offset. It is therefore possible to separate the particles alone from the front surface Wf of the substrate while preventing separation, destruction and the like of the patterns. As newly supplied DIW removes the frozen liquid film, the particles and the like are taken off from the front surface Wf of the substrate.

In the meantime, as the DIW is supplied continuously to the back surface of the substrate, the liquid film does not get frozen and remains fluid from the center of the substrate toward the edge of the substrate. In this respect, one can say that totally different principles from those of the freeze cleaning process realize the cleaning effect which works upon the back surface Wb of the substrate. The history of adopting such a structure will now be described.

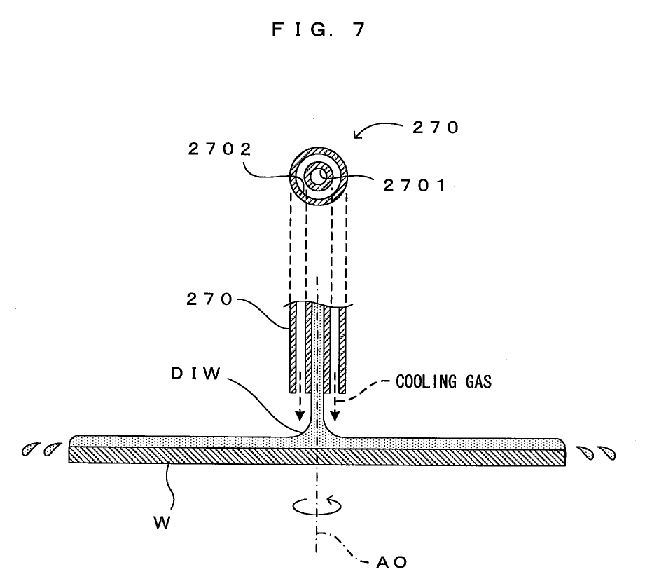

FIG. 7 is a drawing which describes the experiment the inventors of the invention performed. As shown in FIG. 7, using an experimental apparatus capable of discharging DIW and the cooling gas toward substrates, the inventors of the invention examined the effect of removing particles (which are mainly silicon crumbs) while variously changing the operating conditions of the experimental apparatus. In the experimental apparatus, a nozzle 270, which comprises a first discharge outlet 2701 which is open toward the center of the silicon substrate and a second discharge outlet 2702 which is open coaxially to the first discharge outlet 2701 as if to surround the first discharge outlet 2701, is disposed on the central axis of rotation A0 of the rotating substrate W, and it is possible to discharge the cooling gas from the second discharge outlet 2702 while discharging DIW from the first discharge outlet 2701.

Specifically, the standard operation conditions of the experimental apparatus shown in FIG. 7 were as follows:

| | | |
|---|---|---|
| The liquid temperature of DIW: | 0 | degrees Celsius |
| The flow rate of DIW: | 1.2 | L/min |
| The flow rate of the gas: | 100 | L/min |
| The temperature of the gas: | −170 | degrees Celsius |
| The number of rotations of the substrate: | 750 | rpm |
| The processing time: | 10 | sec |

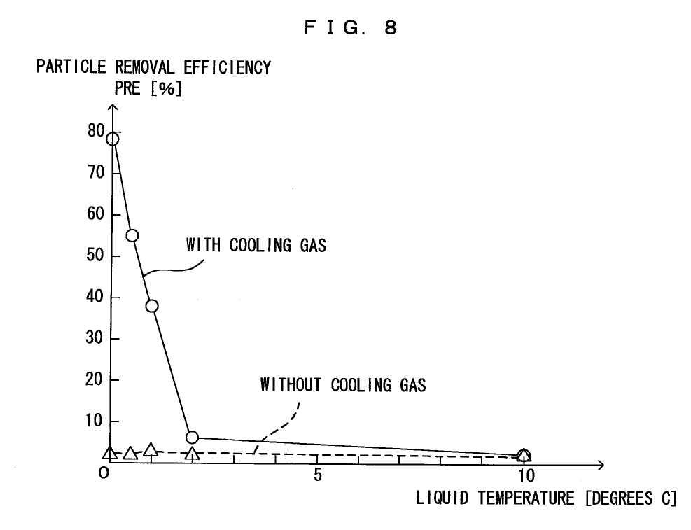

The particle removal efficiency (PRE) was measured while changing the liquid temperature of DIW, the temperature of the cooling gas and the number of rotations of the substrate from the standard values above. FIGS. 8 through 10 show an example of the result.

FIG. 8 is a drawing which shows the relationship between the liquid temperature of DIW and the particle removal efficiency. First, when DIW was supplied to the substrate W without discharging the cooling gas (or while discharging the gas which was at a room temperature), the particle removal efficiency (PRE) remained approximately at 2 to 3% regardless of the liquid temperature of the DIW as indicated by the white triangles in FIG. 8. In contrast, as denoted at the white circles in FIG. 8, where DIW was supplied to the substrate W while supplying the cooling gas (−170 degrees Celsius), the PRE remarkably improved particularly when the liquid temperature of the DIW was 2 degrees Celsius or lower.

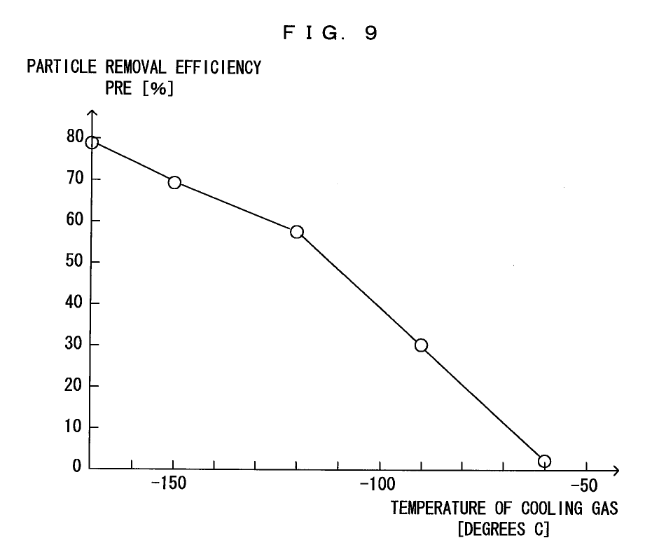

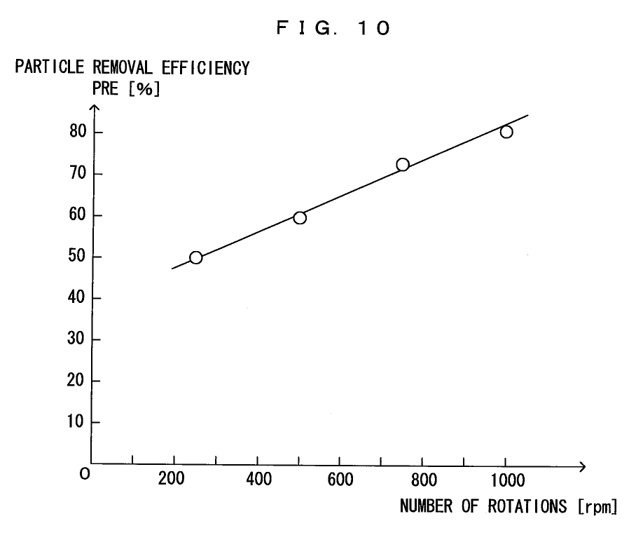

FIG. 9 is a drawing which shows the relationship between the temperature of the cooling gas and the particle removal efficiency. FIG. 10 is a drawing which shows the relationship between the number of rotations of the substrate and the particle removal efficiency. Changing the temperature of the cooling gas in various ways while keeping the liquid temperature of the DIW constant (0 degree Celsius), it was found that the lower the temperature of the cooling gas was, the higher the PRE was as shown in FIG. 9. It was also confirmed as shown in FIG. 10 that the higher the number of rotations of the substrate was, the higher the PRE was.

It has thus been made clear that when the liquid temperature of DIW supplied to the substrate W is cooled down nearly to the freezing point of the DIW and the DIW is supplied to the substrate W together with the cooling gas, the particle removal effect is far better as compared with where room-temperature DIW is simply continuously supplied. Further, appropriately set processing conditions make the PRE better than what it would be with the freeze cleaning process. The high PRE was attained in as short processing time as 10 seconds in the experiment described above. The invention is thus far superior in terms of process throughput than the conventional freeze cleaning process which comprises the steps of forming a liquid film, freezing the liquid film and removing the frozen film.

With respect to the mechanism of removing particles through such processing, the inventors of the invention considered the model below from the fact supported by the experiment that the lower the liquid temperature and the cooling gas temperature were, the greater the particle removal effect was, and further, the higher the number of rotations of the substrate was, the greater the particle removal effect was.

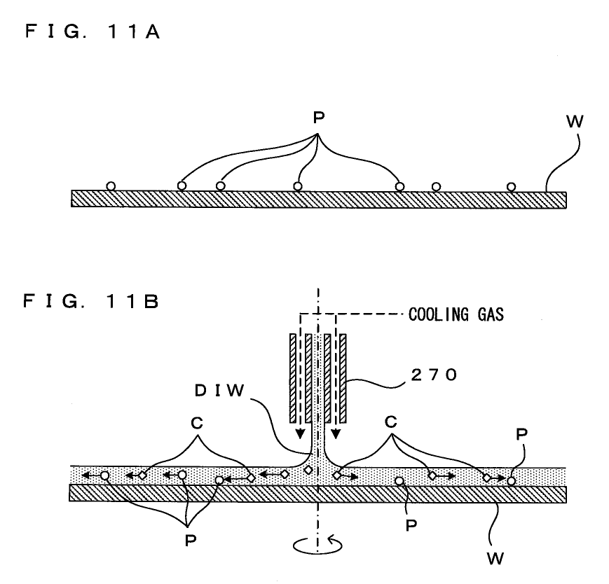

FIGS. 11A and 11B are drawings which show the model of the particle removal mechanism in this cleaning technique. As shown in FIG. 11A, contaminants P such as particles are scattered on a surface of the unprocessed substrate W. According to this cleaning technique, such a substrate W rotates, and DIW cooled down nearly to its freezing point and the cooling gas which is at a lower temperature than the freezing point of the DIW are then supplied. This permits the cooling gas to further cool down and partially freeze the DIW when the DIW which had been discharged toward the substrate W from the nozzle 27 almost reaches or has just reached the substrate W, whereby very small masses of ice C are created in the DIW liquid as denoted at the white diamonds in FIG. 11B. The DIW containing the masses of ice C flows along the surface of the substrate W from the center of the substrate toward the edge of the substrate due to centrifugal force developed by rotations of the substrate W. As this occurs, the masses of ice C in the DIW collide with the particles P adhering to the surface of the substrate W and separate the particles from the surface of the substrate W. The flow of the DIW carry the particles P which have left the substrate W toward the edge of the substrate W, and the particles P are eventually removed from the surface of the substrate W together with drops of the DIW which are shaken off from the substrate at the edge of the substrate.

In this respect, the temperature of the cooling gas needs be lower than the freezing point of the back surface cleaning liquid (which is DIW in this embodiment). The lower the temperature of the cooling gas is, the greater the cleaning effect is.

While one may consider this technique as a technique which uses cleaning liquid in which a solid substance is dispersed in the liquid, since this cleaning technique requires that the solid component has the same composition as that of the cleaning liquid and remains liquid at a room temperature, the solid component will not be left remaining on the cleaned substrate.

This cleaning technique removes particles with liquid (DIW) which remains fluid without freezing a liquid film as a whole. Therefore, with respect to removal of particles entering into inside micro-patterns which would not easily accept entry of liquid, the known freeze cleaning technique is still effective. Meanwhile, as the liquid temperature, the temperature of the cooling gas and the number of rotations of the substrate are set appropriately, the cleaning technique according to the invention attains a higher PRE in a shorter time as compared with the freeze cleaning techniques.

In light of removal of even particles entering into inside micro-patterns, this embodiment applies the freeze cleaning techniques to the front surface Wf of the substrate which is the pattern-seating surface, but noting that it is not possible to form the liquid film thick on the back surface Wb of the substrate which does not seat patterns, the embodiment applies the cleaning technique which is based on the principle described above to the back surface. This makes possible to efficiently remove particles on both the front surface Wf and the back surface Wb of the substrate W. In addition, since it is possible to simultaneously execute the process upon the front surface Wf of the substrate and the process upon the back surface Wb of the substrate, it is possible to clean the both surfaces of the substrate in a short period of time.

Further, in this cleaning technique, the cooling gas is supplied to around DIW which has been supplied to around the center of the substrate, and as thus cooled DIW spreads even to the edge of the substrate due to the centrifugal force, the entire surface of the substrate is cleaned. In short, this cleaning technique requires only to fixedly dispose the nozzle discharging the cooling gas near the center of rotation of the substrate: the technique does not require the nozzle to move. It is therefore possible to favorably clean even the lower surface of the substrate which is hard for the nozzle to scan because of the constraint imposed by the structure.

As described above, according to this embodiment, the back surface Wb of the substrate W is cleaned as DIW serving as the back surface cleaning liquid and the cooling gas for cooling the DIW are discharged from the lower surface nozzle 27, which is disposed below the back surface Wb of the substrate, toward the back surface Wb of the substrate which rotates while held approximately horizontally. As the temperature of the cooling gas is lower than the freezing point of the back surface cleaning liquid, it is possible to attain a high particle removal effect during a short processing time. In particular, supply of the cooling gas while supplying the cleaning liquid makes it possible to process at a higher throughput than a throughput obtainable with the conventional freeze cleaning technique which demands to sequentially form, freeze and remove the liquid film. The particle removal effect would further improve when the DIW which serves as the cleaning liquid is cooled down nearly to its freezing point in advance.

The timing of start supplying the cooling gas is preferably approximately the same time as or slightly behind the start of supply of DIW. The experimental result described earlier has made it clear that supply of only DIW without any supply of the cooling gas would not improve the cleaning effect. Meanwhile, it is considered that when the cooling gas is supplied before supplying DIW, the substrate receiving the cooling gas would be cooled and the discharged DIW would soon get frozen. It is therefore most efficient to start supplying the cooling gas approximately at the same time as or with a slight delay from the start of supply of DIW to time the arrival of the cooling gas with the arrival of the discharged DIW at the front surface of the substrate.

In addition, as the supply of the cooling gas is stopped first while still keeping the supply of DIW, particles and the like separated from the substrate are more securely washed away from the front surface of the substrate. In this regard, it is preferable to stop supplying the cooling gas first before stop supplying DIW.

Further, since the cleaning liquid is left fluid without entirely freezing the liquid film on the substrate according to this cleaning technique, as the cleaning liquid and the cooling gas are supplied to near the center of the substrate while the substrate rotates, the cleaning liquid covers and cleans the entire surface of the substrate. That is, it is possible to attain a high cleaning effect on the entire surface of the substrate without moving the nozzle which discharges the cooling gas. As it is not necessary to move the nozzle, it is possible to attain a high cleaning effect on the lower surface of the substrate as well which is held horizontally.

Further, as the lower surface is cleaned at the same time as the cleaning process on the upper surface of the substrate which is held horizontally, it is possible to clean the both surfaces of the substrate in a short period of time. In the event that one of the surfaces of the substrate seats patterns, this pattern-seating surface is held facing up and the known freeze cleaning technique is applied to this upper surface, and the opposite surface to the pattern-seating surface is cleaned using the cleaning technique described above. It is therefore possible to efficiently clean the both surfaces of the substrate while preventing damages upon the patterns.

The substrate processing apparatus according to the second embodiment of the invention will now be described. The first embodiment of the invention described above applies the known freeze cleaning technique to clean the upper surface of the substrate W but applies the cleaning technique according to the invention to clean the lower surface. However, the cleaning technique according to the invention is applicable not only to cleaning of the lower surface of the substrate, but also to cleaning of the upper surface of the substrate in addition. It is further possible to clean both the top and the lower surfaces of the substrate at the same time using the cleaning technique according to the invention, as described below in relation to the second embodiment.

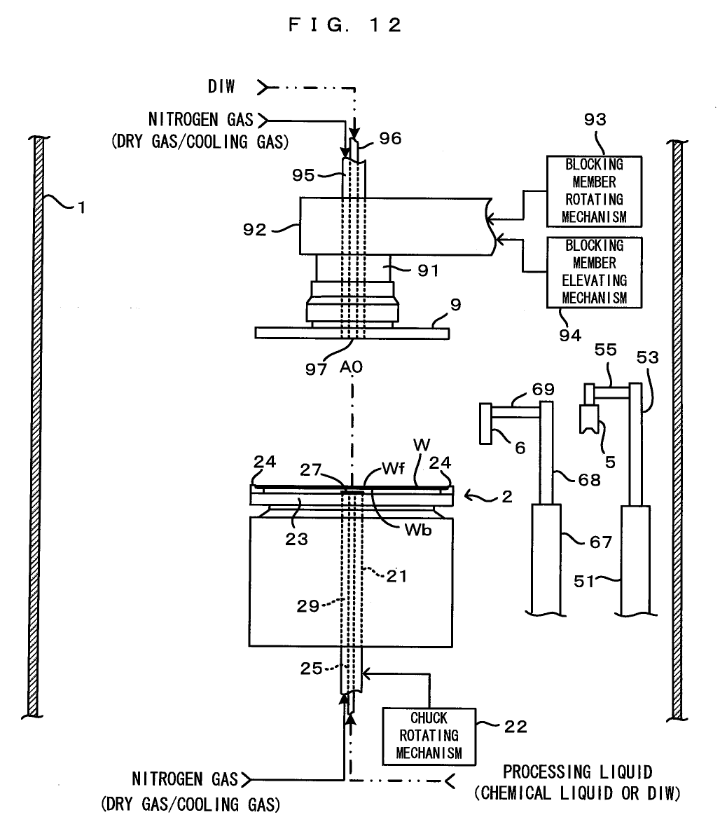

FIG. 12 is a drawing which shows the substrate processing apparatus according to the second embodiment of the invention. Except for omission of the cooling gas discharge nozzle and the associated mechanisms, the structure of the apparatus according to this embodiment is basically the same as the structure according to the first embodiment shown in FIG. 1, and the operations are only partially different. The same structures as those of the apparatus according to the first embodiment will therefore be only denoted at the same reference symbols but will not be described again.

As for nitrogen gas from the nitrogen gas supply part 64 to the gas supply pipe 95 connected with the blocking member 9, the substrate processing apparatus according to this embodiment is capable of supplying it as cooling gas coming through the heat exchanger 642 or as dry gas not coming through the heat exchanger 642. In short, it is capable of selectively discharging from the lower surface of the blocking member 9 as the room-temperature dry gas or the cooling gas at a lower temperature than the freezing point of DIW. In a similar way, from the nozzle 97 which is disposed to the lower surface of the blocking member 9, it is possible to selectively discharge room-temperature DIW from the DIW supply part 62 or DIW cooled by the heat exchanger 622 nearly down to its freezing point.

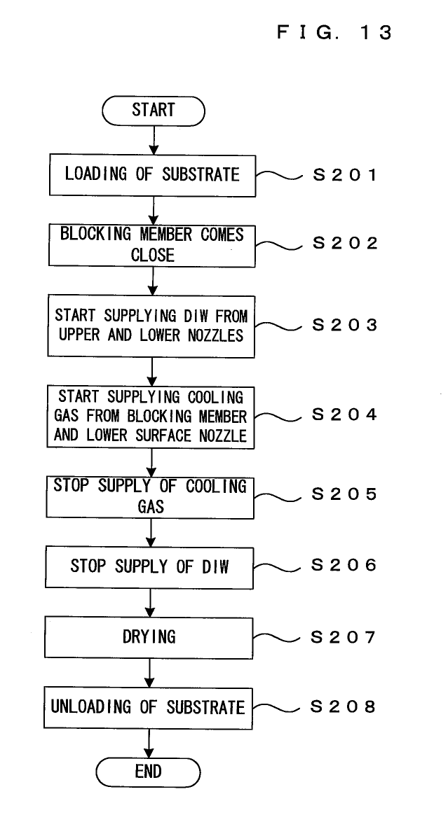

FIG. 13 is a flow chart which shows the cleaning operation of the substrate processing apparatus of FIG. 12. This operation is the same as that in the first embodiment up until the substrate W is loaded and the blocking member 9 comes positioned at the opposed position facing the substrate (Steps S201, S202). Following this, the blocking member 9 and the spin base 23 rotate in the same direction at the same rotation speed, and the nozzle 97 which is disposed to the blocking member 9 and the lower surface nozzle 27 disposed to the spin base start supplying DIW, which has been cooled down to a temperature close to its freezing point and would serve as the cleaning liquid, toward the center of rotation of the substrate (Step S203). Further, approximately at the same time as this or slightly after this, the blocking member 9 and the spin base 23 start supplying the cooling gas (Step S204).

This causes both the front surface Wf and the back surface Wb of the substrate to see the phenomenon described earlier to occur at the lower surface Wb of the substrate in the first embodiment namely, the phenomenon that DIW further cooled down by the cooling gas flows on the substrate W from the center of the substrate W toward the edge of the substrate W. As described above, as the cooling gas cools down DIW supplied to the substrate W while the substrate W rotates, the particle removal effect works powerfully in a short period of time. In this embodiment, since this cleaning method is exercised on both the front surface Wf and the back surface Wb of the substrate simultaneously, it is possible to effectively clean the both surfaces of the substrate W in a short period of time.

The supply of the cooling gas is stopped after continued for a predetermined period of time (Step S206), followed by supply of DIW alone, thereby removing particles and the like remaining on the substrate more securely from the substrate. After that, as in the first embodiment, the supply of DIW is then stopped (Step S207), drying is performed and the substrate is unloaded (Steps S207, S208), and the cleaning process on the substrate W thus completes.

This embodiment as well achieves a high particle removal effect on the both surfaces of the substrate W. To be particularly noted, since the cleaning technique according to the invention is applied to the upper surface side of the substrate W as well, it is possible to obtain the cleaning effect in a shorter time than where one performs the freeze cleaning technique requiring to form, freeze and remove a liquid film in this order. The throughput of the cleaning process therefore dramatically improves. Further, since a mechanism for discharging the cooling gas in a scanning action is not necessary, the structure of the apparatus may be simple and compact. This embodiment is particularly preferable to cleaning of the substrate whose front or back surfaces has no patterns yet.

As described above, in these embodiments, the substrate processing apparatuses (FIGS. 1 and 12) correspond to the “substrate cleaning apparatus” of the invention while the spin chuck 2 functions as the “substrate holder” of the invention. The DIW supply part 62 functions as the “the cleaning liquid supplier” of the invention, and the heat exchanger 622 functions as the “pre-cooler” of the invention. Further, in these embodiments, the nitrogen gas supply part 64 functions as the “cooling gas supplier” of the invention, and the lower surface nozzle 27 corresponds to the “nozzle” of the invention.

In addition, in these embodiments, the Steps S121 and S122 in the flow chart in FIG. 4 and the Step S204 in the flow chart in FIG. 13 correspond to the “cleaning liquid supplying step” of the invention. Meanwhile, the Step S132 in the flow chart in FIG. 4 and the Step S207 in the flow chart in FIG. 13 correspond to the “cleaning liquid removing step” of the invention.

The invention is not limited to the embodiments described above but may be modified in various manners in addition to the embodiments above, to the extent not deviating from the object of the invention. For instance, although the embodiments above use DIW as the “cleaning liquid” of the invention, the cleaning liquid is not limited to this. The cleaning liquid may for example be carbonated water, hydrogen water, ammonia water having a diluted concentration (of approximately 1 ppm for instance), hydrochloric acid having a diluted concentration, DIW to which a small amount of a surface activating agent is added, etc.

Further, although nitrogen gas which has become to have different temperatures after coming from the same nitrogen gas reservoir is used as the cooling gas and the dry gas in the embodiments above, the dry gas and the cooling gas are not limited to nitrogen gas. One or both of the cooling gas and the dry gas may be dry air or other inert gas for instance. The cooling gas in particular is for the purpose of cooling the cleaning liquid and will not directly contact the substrate, dry air is preferably usable as the cooling gas.

Further, although the first discharge outlet for discharging DIW and the second discharge outlet for discharging the cooling gas are coaxial structures in the embodiments above, they are not limited to such structures. For instance, the first discharge outlet for discharging the cleaning liquid may be disposed on the rotation axis of the substrate and the second discharge outlet for discharging the cooling gas may be disposed on the side of the first discharge outlet. While the cooling gas is discharged in an asymmetric relationship with respect to the rotation axis of the substrate in this structure, as the substrate rotates, substantially isotropic processing is realized.

Further, DIW serving as the cleaning liquid and nitrogen gas serving as the cooling gas are discharged in the same direction, that is, toward the substrate in the embodiments above. However, the cooling gas does not necessarily need be discharged toward the substrate but may be discharged toward the liquid column of the cleaning liquid which is discharged toward the substrate.

Further, although the DIW reservoir 621 and the nitrogen gas reservoir 641 are provided within the substrate processing apparatus according to each embodiment described above, the sources of the cleaning liquid and the gas may be disposed outside the apparatus: for instance, the existing sources of the cleaning liquid and the gas in a plant may be utilized. Where an existing facility for cooling them is available, the cleaning liquid and the gas cooled by this facility may be utilized.

Further, while the substrate processing apparatus according to each embodiment described above comprises the blocking member 9 which is disposed close to but above the substrate W, the invention is applicable also to an apparatus which does not comprise the blocking member. In addition, while the chuck pins 24 which abut on the rim of the substrate W hold the substrate W in the apparatuses according to the embodiments, the method of holding the substrate is not limited to this: the invention is applicable also to an apparatus which holds the substrate by other method.

The first embodiment is for clean the front surface of the substrate by the known freeze cleaning technique and the back surface of the substrate by the cleaning technique according to the invention. Meanwhile, the second embodiment is for clean the both surfaces of the substrate by the cleaning technique according to the invention. However, the invention is not limited to these embodiments but is applicable also to cleaning of only one surface of the substrate.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

In the invention, the cleaning liquid may be supplied toward the center of rotation of the substrate while rotating the substrate which is held approximately horizontally. Since centrifugal force which develops as the substrate rotates causes the cleaning liquid to flow from the center of the substrate to the edge of the substrate, it is possible to ensure that the cleaning liquid covers the entire surface of the substrate. The experiment by the inventors of the invention performed verified the correlation between the particle removal effect and the number of rotations of the substrate, from which one can see that the particle removal effect would improve as the substrate rotates.

In this instance, the cooling gas may be supplied toward the supply position on the substrate at which the substrate receives the cleaning liquid or toward around the supply position. Since this permits the centrifugal force to outwardly spread the cleaning liquid which has been cooled by the cooling gas, it is not necessary to change the supply position for the cooling gas, and it is therefore possible to simplify the structure as compared with where one uses the conventional technique which requires scanning of the cooling gas nozzle.

Further, the supply of the cleaning liquid and the supply the cooling gas may be started simultaneously. The supply of the cleaning liquid to the surface of the substrate without using the cooling gas would not attain a sufficient particle removal effect. The supply of the cooling gas before supplying the cleaning liquid would result only in cooling of the substrate, which is meaningless. When the supply of the cleaning liquid and the supply of the cooling gas start simultaneously, the cleaning liquid and the cooling gas effectively would contribute to cleaning.

Further, the supply of the cooling gas may be stopped before stopping the supply of the cleaning liquid. Where this is implemented, after the cooling gas has been stopped, the cleaning liquid which has not been cooled is supplied to the surface of the substrate, which allows the function of the cooled cleaning liquid to wash away particles leaving the substrate and prevent the particles from remaining on the substrate.

As for the cleaning liquid discharged toward the substrate, the cleaning liquid as it is cooled in advance down to a temperature near its freezing point may be supplied toward the substrate. This further enhances the cooling effect upon the cleaning liquid by the cooling gas and attains an even greater cleaning effect upon the substrate.

The substrate cleaning apparatuses described above may further comprise a nozzle including a first discharge outlet which is open toward the substrate on the rotation axis of the substrate and a second discharge outlet which is open in the vicinity of the first discharge outlet, the cleaning liquid from the cleaning liquid supplier may be discharged at the first discharge outlet of the nozzle, and the cooling gas from the cooling gas supplier may be discharged at the second discharge outlet of the nozzle.

In the nozzle, the second discharge outlet may be disposed coaxially to the first discharge outlet and as if to surround the first discharge outlet. This makes the second discharge outlet discharge the cooling gas as if to surround the cleaning liquid which is discharged at the first discharge outlet toward the center of rotation of the substrate, whereby the cleaning liquid is efficiently cooled and the cleaning effect improves.

Further, the nozzle may be disposed below the substrate with its first and second discharge outlets facing up to thereby discharge the cleaning liquid and the cooling gas toward the lower surface of the substrate. With this structure, it is possible to supply the cleaning liquid and the cooling gas toward the lower surface of the substrate held approximately horizontally and to remove particles and the like adhering to the lower substrate of the substrate. It is difficult in terms of structure to apply the conventional freeze cleaning technique, which requires scanning the nozzle which discharges the cooling gas near the surface of the substrate, to the lower surface side of the substrate. In contrast, as the cleaning liquid and the cooling gas may be supplied from near the center of rotation of the substrate according to the invention, the nozzle does not need to scan, and it is therefore possible to preferably apply the invention to cleaning of the lower surface of the substrate as well. Further, combination with the processing of the upper surface of the substrate is also possible, in which case the processing of the upper surface may be either one of the cleaning technique according to the invention and the known freeze cleaning technique.

These substrate cleaning apparatuses may comprise a pre-cooler which pre-cools the cleaning liquid down to a temperature near the freezing point of the cleaning liquid in advance. This further enhances the cooling effect upon the cleaning liquid by the cooling gas and achieves an even greater cleaning effect on the substrate.

### INDUSTRIAL APPLICABILITY

The invention is applicable to a substrate processing apparatus for freezing liquid films formed on surfaces of substrates in general, such as semiconductor wafers, glass substrates for photomasks, glass substrates for liquid crystal displays, glass substrates for plasma displays, FED (Field Emission Display) substrates, optical disk substrates, magnetic disk substrates and substrates for magnetooptical disks, and also to a liquid film freezing method and a substrate processing method which uses the liquid film freezing method.

### DESCRIPTION OF THE REFERENCES

2 . . . spin chuck (substrate holder)
3 . . . cooling gas discharge nozzle
9 . . . blocking member
27 . . . lower surface nozzle (nozzle)
62 . . . DIW supply part (cleaning liquid supplier)
622 . . . heat exchanger (pre-cooler)
64 . . . nitrogen gas supply part (cooling gas supplier)
W . . . substrate
Wf . . . front surface of substrate (pattern-seating surface)
Wb . . . back surface of substrate

1. A substrate cleaning method, comprising:
a cleaning liquid supplying step of discharging and supplying cleaning liquid toward a substrate; and
a cleaning liquid removing step of removing the cleaning liquid remaining on a surface of the substrate after the cleaning liquid supplying step,
wherein at the cleaning liquid supplying step, while discharging the cleaning liquid, cooling gas which is at a lower temperature than a freezing point of the cleaning liquid is supplied toward the cleaning liquid thus discharged.

2. The substrate cleaning method of claim 1,
wherein at the cleaning liquid supplying step, while holding the substrate horizontally and rotating the substrate, the cleaning liquid is supplied toward a center of rotation of the substrate.

3. The substrate cleaning method of claim 2,
wherein at the cleaning liquid supplying step, the cooling gas is supplied toward a supply position on the substrate at which the substrate receives the cleaning liquid or toward around the supply position.

4. The substrate cleaning method of any one of claims 1 through 3,
wherein at the cleaning liquid supplying step, the supply of the cleaning liquid and the supply of the cooling gas start simultaneously.

5. The substrate cleaning method of claim 4,
wherein at the cleaning liquid supplying step, the supply of the cooling gas is stopped before the supply of the cleaning liquid is stopped.

6. The substrate cleaning method of claim 1,
wherein at the cleaning liquid supplying step, the cleaning liquid which has been cooled in advance down to a temperature near its freezing point is supplied toward the substrate.

7. A substrate cleaning apparatus, comprising:
a substrate holder which holds a substrate;
a cleaning liquid supplier which discharges and supplies cleaning liquid toward the substrate which is held by the substrate holder; and
a cooling gas supplier which supplies cooling gas to the cleaning liquid which is discharged by the cleaning liquid supplier,
wherein the cooling gas supplier supplies the cooling gas which is at a lower temperature than a freezing point of the cleaning liquid to the cleaning liquid which is discharged toward the substrate by the cleaning liquid supplier.

8. The substrate cleaning apparatus of claim 7,
wherein the substrate holder rotates the substrate while holding the substrate horizontally, and the cleaning liquid supplier supplies the cleaning liquid toward a center of rotation of the substrate.

9. The substrate cleaning apparatus of claim 8,
wherein the cooling gas supplier supplies the cooling gas toward a supply position on the substrate at which the substrate receives the cleaning liquid or toward around the supply position.

10. The substrate cleaning apparatus of claim 7, further comprising a nozzle which includes a first discharge outlet which is open toward the substrate on a rotation axis of the substrate and a second discharge outlet which is open in a vicinity of the first discharge outlet,
wherein the cleaning liquid from the cleaning liquid supplier is discharged at the first discharge outlet of the nozzle, and the cooling gas from the cooling gas supplier is discharged at the second discharge outlet of the nozzle.

11. The substrate cleaning apparatus of claim 10,
wherein the second discharge outlet is coaxial with respect to the first discharge outlet and surrounds the first discharge outlet in the nozzle.

12. The substrate cleaning apparatus of claim 10,
wherein the nozzle is disposed below the substrate with the first and the second discharge outlets facing up to thereby discharge the cleaning liquid and the cooling gas toward a lower surface of the substrate.

13. The substrate cleaning apparatus of claim 7, further comprising a pre-cooler which pre-cools the cleaning liquid to be discharged toward the substrate down to a temperature near the freezing point of the cleaning liquid in advance.
